(19) United States
(12) Patent Application Publication
(10) Pub. No.: US 2026/0355746 A1
(43) Pub. Date: Nov. 12, 2026

(54) WELL PLATE INSERTS FOR AUTOMATED ULTRA-LOW VOLUME SAMPLING

(71) Applicant: The Board of Trustees of The University of Alabama, Tuscaloosa, AL (US)

(72) Inventors: Kellye Anne Sutton, Tuscaloosa, AL (US); Si Wu, Tuscaloosa, AL (US); Samin Anjum, Tuscaloosa, AL (US)

(21) Appl. No.: 19/673,071

(22) Filed: May 11, 2026

Related U.S. Application Data
(60) Provisional application No. 63/804,070, filed on May 12, 2025.

(51) Int. Cl. B01L 3/00; G01N 35/10

(52) U.S. Cl. CPC B01L 3/508; G01N 35/10; B01L 2300/0832; B01L 2300/0858

(57) ABSTRACT

A sample container is disclosed including a tapering body extending from a top end to a tip end of the sample container along a central longitudinal axis. The tip end has a first diameter smaller than a second diameter of the top end of the tapering body. The tapering body has an outer surface and an inner surface with a thickness defined between the outer surface and the inner surface. The sample container includes an opening defined on the top end of the tapering body. The sample container includes a cavity defined by the inner surface of the tapering body to be in fluid communication with the opening, wherein the tip end of the sample container is configured to fit within a sample well to facilitate automated collection of a sample fluid disposed within the cavity by an external collection device.

### CROSS-REFERENCE TO RELATED APPLICATIONS

This application claims priority to and the benefit of U.S. Provisional Application No. 63/804,070, filed May 12, 2025, the entire contents of which are incorporated herein by reference.

### GOVERNMENT LICENSES RIGHTS

This invention was made with government support under grant nos. R01AI141625 and 2U19AI062629 awarded by the National Institutes of Health. The government has certain rights in the invention.

### BACKGROUND

Collection and analysis of mass-limited samples (e.g., in proteomics, metabolomics, transcriptomics, etc.), such as clinical samples, rare cells, and single cells, is a growing area of research. However, analysis of these mass-limited samples is challenging due to the limited biological material. One bottleneck to this analysis is nonspecific adhesion of protein to vessel walls. This adhesion is exacerbated by dilution of mass-limited samples. More generally, automated sampling devices are often not equipped to collect mass-limited samples, requiring dilution of the sample fluid, which reduces accuracy and sensitivity.

Therefore, a need exists for improved mass-limited sampling systems and techniques.

### SUMMARY

According to one implementation, a glass insert for well plates is disclosed to reduce the sample volume requirement for an automated sampling device. For example, the disclosed insert devices or sample containers may be used in a capillary-electrophoresis mass spectrometry (CE-MS)-based proteomics device or system. The disclosed inserts facilitate automated micro-sampling from as little as 500 nL-2 μL of a sample, eliminating the need to dilute a sample and maintaining the concentration of the sample. In some implementations, the insert devices reduce the volume of the well within which the sample fluid is disposed while simultaneously raising the floor of the well. In some implementations, the insert device enables the collection tube of a given machine to reach the bottom of the well without changing its standard operating procedures.

The sample container or sample well insert device disclosed herein provides a highly reproduceable and consistent device for automated sampling. The dimensions and geometry of the well insert device is configurable to a wide variety of sample wells, including different existing instruments. Rather than re-configured existing sampling devices, which can be expensive and time consuming, the disclosed sample container provides a quick and seamless solution for mass limited sampling in existing sampling devices. Thus, a user requiring low-volume sample can simply use the disclosed sample container having a smaller cavity volume instead of diluting the same sample to fit with existing sampling device configurations.

According to one implementation, a sample container is disclosed. The sample container includes a tapering body extending from a top end to a tip end of the sample container along a central longitudinal axis. The tip end has a first diameter smaller than a second diameter of the top end of the tapering body. The tapering body has an outer surface and an inner surface with a thickness defined between the outer surface and the inner surface. The tapering body further includes an opening defined on the top end of the tapering body. A cavity is defined by the inner surface of the tapering body to be in fluid communication with the opening. The tip end of the sample container is configured to fit within a sample well to facilitate automated collection of a sample fluid disposed within the cavity by an external collection device.

In some implementations, a volume of the sample fluid disposed in the cavity is less than 1000 nanoliters (e.g., 500 nL).

In some implementations, the sample well is a test tube defining a test tube opening in fluid communication with the sample well, wherein the sample well is sized to fit a majority of the sample container therein, wherein the second diameter of the top end of the tapering body is greater than or equal to a diameter of the test tube opening such that the sample container is retained on an upper end of the test tube.

In some implementations, the sample well is one of a plurality of sample wells defined in a multi-well plate, the sample well extending from a first opening defined by a top surface of the multi-well plate towards a bottom surface of the sample well, wherein the sample well is sized to fit a majority of the sample container therein, wherein the second diameter of the top end of the tapering body is greater than or equal to a diameter of a first opening such that the sample container is retained on an upper end of the sample well.

In some implementations, the tip end of the sample container is spaced apart from the bottom surface of the sample well. In some implementations, the tapering body includes glass.

In some implementations, the first diameter is less than or equal to 4 millimeters (e.g., 3mm) and the second diameter is at least 5 millimeters (e.g., 6mm). In some implementations, a height of the sample container from the tip end to the top end is at least 8 millimeters (e.g., 10mm).

In some implementations, the tapering body is substantially cone-shaped, and the corresponding cavity defined by the inner surface is substantially cone-shaped. In some implementations, the opening on the top end of the tapering body has an oblong shape in a direction perpendicular to the central longitudinal axis.

According to one implementation, a sampling system to facilitate automated sample collection is disclosed. The sampling system includes a plate that includes an upper surface defining a plurality of openings, including a first opening, and a plurality of sample wells defined in the plate. The plurality of sample wells extend from and is in fluid communication with the plurality of openings, including a first sample well extending from the first opening. Each of the plurality of sample wells includes a bottom, wherein the plate is configured to be mounted within an automated sampling device. The system further includes at least one sample container, including a first sample container configured to be placed within the first sample well. The at least one sample container includes a tapering body extending from a top end to a tip end of the at least one sample container along a central longitudinal axis. The tip end has a first diameter smaller than a second diameter of the top end of the tapering body. The tapering body has an outer surface and an inner surface with a thickness defined between the outer surface and the inner surface. An opening is defined on the top end of the tapering body. A cavity is defined by the inner surface of the tapering body to be in fluid communication with the opening. When the first sample container is disposed within the first sample well, the tip end of the first sample container is spaced apart from the bottom of the first sample well such that the first sample container is disposed on an upper portion of the first sample well to facilitate automated collection of a sample fluid disposed within the cavity of the first sample container by the automated sampling device.

In some implementations, the at least one sample container further includes a second sample container configured to be disposed within a second sample well of the plurality of sample wells of the plate, wherein the second sample well is spaced apart from the first sample well in a lateral direction that is perpendicular to a longitudinal axis of the first sample well.

In some implementations, the automated sampling device includes a sample collection tube configured to extend into the first sample container disposed within the first sample well. In some implementations, the sample collection tube extends towards a bottom of the cavity of the first sample container to contact and collect the sample fluid therein.

In some implementations, the sample collection tube of the automated sampling device has a diameter of less than 500 micrometers. In some implementations, the plate is a 96-well plate and the plurality of sample wells includes 96 sample wells. In some implementations, a volume of the sample fluid disposed in the cavity of the first sample container is less than 1000 nanoliters (e.g., 500 nL).

In some implementations, the tapering body of the first sample container includes glass. In some implementations, the tapering body of the first sample container is substantially cone-shaped, and the corresponding cavity defined by the inner surface is substantially cone-shaped. In some implementations, the opening on the top end of the tapering body of the first sample container has an oblong shape in a direction perpendicular to the central longitudinal axis.

This summary is illustrative only and is not intended to be in any way limiting. Other aspects, features, and advantages of the devices or processes described herein will become apparent in the detailed description set forth herein, taken in conjunction with the accompanying figures, wherein like reference numerals refer to like elements.

### BRIEF DESCRIPTION OF DRAWINGS

The systems, methods, and devices are explained in even greater detail in the following drawings. The drawings are merely exemplary and certain features may be used singularly or in combination with other features. The drawings are not necessarily drawn to scale.

FIG. 1A shows a well plate insert or a sample container, according to one implementation.

FIG. 1B shows the sample container of FIG. 1A with exemplary dimensions.

FIGS. 2A-2C each show an image of a glass sample container, according to one implementation.

FIG. 3 shows a test tube defining a sample well with a sample container retained therein, according to one implementation.

FIG. 4 shows a 96-well plate having a sample container retained within a sample well thereof, according to one implementation.

FIG. 5 shows a diagram of a sample container, a well plate, and an automated sampling device, according to one implementation.

FIG. 6 shows a diagram of a collection tube inserted into the cavity of a sample container along with example types of collection tubes, according to one implementation.

### DETAILED DESCRIPTION

Following below are more detailed descriptions of concepts related to, and implementations of, methods, apparatuses, and systems for mass-limited sampling and well inserts facilitating mass-limited sampling. The figures illustrate exemplary implementations in detail and the present disclosure is not limited to the details or methodology set forth in the description or illustrated in the figures. The terminology used herein is for the purpose of description only and should not be regarded as limiting.

In general, mass limited samples may be analyzed to identify certain biomarkers or other characteristics. Mass limited samples may be collected and analyzed by an automated machine or system, such as an autosampler machine. One such method of analysis is mass spectrometry, which can analyze the chemical makeup of a given sample. Mass spectrometry (MS) is often coupled with separation methods such as capillary electrophoresis (CE) and reversed-phase liquid chromatography (RPLC). Capillary electrophoresis separates biological molecules (proteins, metabolites, DNA, RNA, etc.) based on their electrophoretic mobility in a high-voltage electric field. RPLC separates molecules based on their hydrophobicity. When combined with mass spectrometry, these techniques enable effective detection and characterization of complex biological samples.

In systems utilizing capillary electrophoresis mass spectrometry or RPLC-MS, or in other similar systems, a relatively high sample volume may be used with a diluted sample. For example, current sampling strategies using electrokinetic injection and pressure-based injection methods require as much as 5 μL of sample due to current limitations. The dilution reduces the sensitivity of the resulting measurements. In some implementations, the volume required for a given sampling procedure depends on (i) the volume of the well within which the sample fluid is disposed, and (ii) the extent to which a collection tube extends into the well (e.g., how “low” into the well that a collection tube can extend). Existing systems are limited in both the volume of the wells used and the distance that the collection tubes extend into the wells.

According to one implementation, a glass insert for well plates is disclosed to reduce the sample volume requirement for an automated sampling device. For example, the disclosed insert devices or sample containers may be used in a capillary-electrophoresis mass spectrometry (CE-MS)-based proteomics device or system. The disclosed inserts facilitate automated micro-sampling from as little as 500 nL-2 μL of a sample, eliminating the need to dilute a sample and maintaining the concentration of the sample. In some implementations, the insert devices reduce the volume of the well within which the sample fluid is disposed while simultaneously raising the floor of the well. In some implementations, the insert device enables the collection tube of a given machine to reach the bottom of the well without changing its standard operating procedures.

The sample container or sample well insert device disclosed herein provides a highly reproduceable and consistent device for automated sampling. The dimensions and geometry of the well insert device is configurable to a wide variety of sample wells, including different existing instruments. Rather than re-configured existing sampling devices, which can be expensive and time consuming, the disclosed sample container provides a quick and seamless solution for mass limited sampling in existing sampling devices. Thus, a user requiring low-volume sample can simply use the disclosed sample container having a smaller cavity volume instead of diluting the same sample to fit with existing sampling device configurations.

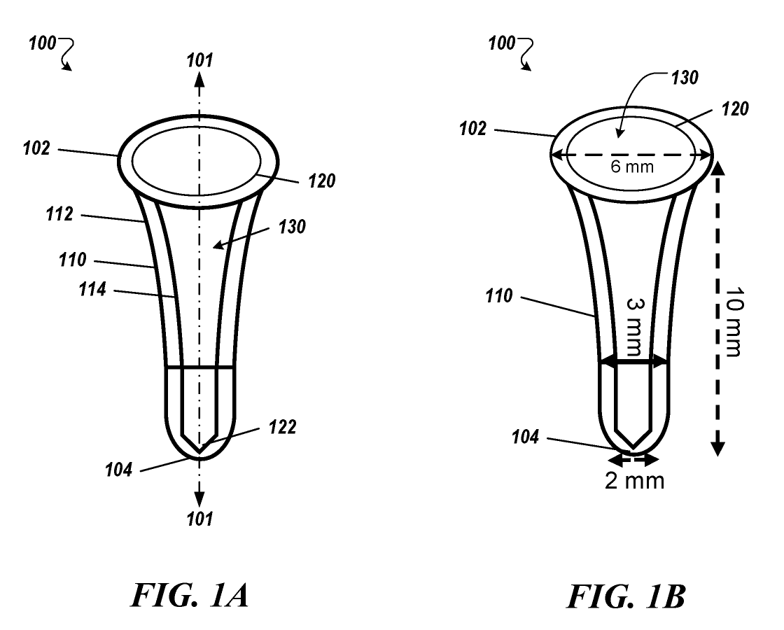

FIG. 1A shows a well insert device or sample container 100, according to one implementation. FIG. 1B shows the sample container 100 of FIG. 1A with exemplary dimensions. These dimensions are one example only and do not limit the scope of the application or the claims presented herein.

As shown in FIG. 1A, the sample container 100 includes a tapering body 110. The tapering body 110 extends from a top end 102 of the sample container 100 to a tip end 104 of the sample container 100 along a central longitudinal axis 101. The top end 102 is spaced apart from the tip end 104 along the central longitudinal axis 101.

The top end 102 of the tapering body 110 of the sample container 100 has a top diameter. The tip end 104 of the tapering body 110 of the sample container 100 has a tip diameter. Generally, the tip diameter is smaller than the top diameter. In other words, the tapering body 110 tapers towards the tip end 104. The tapering body 110 is generally cone-shaped or frusto-conical shaped, wherein the widest diameter is adjacent to or coincident with the top end 102 and the narrowest diameter is adjacent to or coincident with the tip end 104 of the sample container 100.

The tapering body 110 further includes an outer surface 112 and an inner surface 114. A thickness of the tapering body 110 is defined between the outer surface 112 and the inner surface 114 (e.g., in a substantially radial direction relative to the central longitudinal axis 101). The outer surface 112 extends from the top end 102 to the tip end 104 of the tapering body 110.

An opening 120 is defined on the top end 102 of the tapering body 110. The opening 120 is substantially circular in shape. However, in other implementations, the opening may have other shapes (e.g., an oblong shape in a direction perpendicular to the central longitudinal axis, a polygonal shape, or an irregular shape). The opening 120 is substantially aligned with the central longitudinal axis 101 (e.g., a center of the opening 120 is coincident with the central longitudinal axis 101).

The sample container 100 further includes a cavity 130 defined by the inner surface 114. The cavity 130 is in fluid communication with the opening 120. The opening 120 is aligned with the inner surface 114, and the inner surface inner surface 114 extends from the opening 120 on the top end 102 towards the tip end 104 of the sample container 100. The inner surface 114 and the cavity 130 extend to a bottom surface 122 adjacent to, but spaced apart from, the tip end 104 of the tapering body 110. For example, the bottom surface 122 is spaced apart from the tip end 104 by the thickness of the tapering body 110. Thus, the end of the cavity 130 closest to the bottom surface 122 includes the smallest diameter of the opening 120.

The cavity 130 is substantially cone-shaped, similar to the outer surface 112 of the tapering body 110. The tapering body 110 and the cavity 130 are each substantially symmetrical about the central longitudinal axis 101.

As shown in FIG. 1B, the sample container 100 has an overall height measured in the longitudinal direction from the top end 102 to the tip end 104. In some implementations, the height is at least 8 millimeters (e.g., 10 mm as shown). As shown in FIG. 1B, top end 102 of the sample container 100 has a diameter of at least 5 mm (e.g., 6 mm as shown). The opening 120 on the top end 102 has an opening diameter of at least 4 mm (e.g., 5 mm when the thickness of the tapering body 110 is 1 mm). The tip end 104 of the sample container 100 has a tip diameter of less than or equal to 4 mm (e.g., 3 mm as shown). The cavity 130 near the tip end 104 has a diameter of less than or equal to 3 mm (e.g., 2 mm as shown). The tapering body 110 of the sample container 100 is FIG. 1B thus has a thickness between the outer surface 112 and the inner surface 114 of 1 mm. However, in other implementations, the thickness may be in the range of 0.5 – 2 mm.

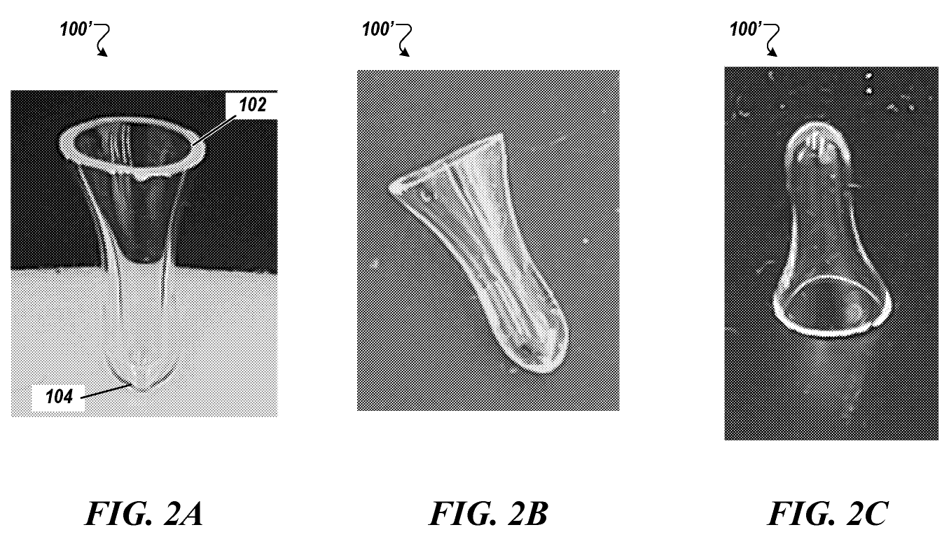

FIGS. 2A-2C show images of a glass sample container 100’ substantially similar to that of FIGS. 1A and 1B. The sample container 100’ generally comprises glass. However, in other implementations, the sample containers of the present disclosure may include other similar inert materials. The sample container 100’ may be manufactured from a glass blowing process which may include (i) forming a tapered body defining a central cavity and (ii) cutting the wide end of the tapered body to form the opening on the top end of the sample container. However, in other implementations, the disclosed sample container may be manufactured by a different process (e.g., molding, casting, or forming a glass, plastic, metal, or composite material).

The sample container 100 of FIGS. 1A-1B (or other implementations thereof) is generally configured to fit within a sample well. For example, the tip end 104 of the sample container 100 is configured to fit within a sample well to facilitate automated collection of a sample fluid disposed within the cavity 130 by an external device. In some implementations, the volume of the sample fluid disposed in the cavity 130 is less than 1000 nanoliters (e.g., 500 nL). For example, the sample fluid within the cavity 130 may be an undiluted sample.

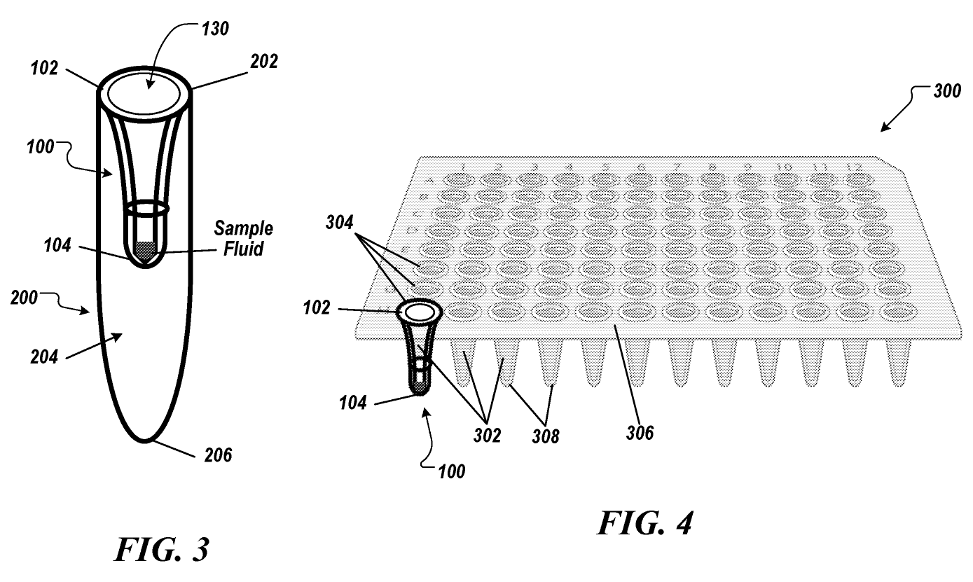

As shown in FIG. 3, the sample container 100 is configured to fit within a test tube 200. Specifically, the test tube 200 defines a test tube opening 202 in fluid communication with a sample well 204. The sample well 204 defined by the test tube 200 is sized to fit a majority of the sample container 100 therein. The diameter of the top end 102 of the sample container 100 is greater than or equal to a diameter of the test tube opening 202. Thus, the sample container 100 is retained on an upper end of the test tube 200. The tip end 104 of the sample container 100 is spaced apart from a tip end 206 of the test tube 200.

When disposed within the test tube 200, the sample container 100 essentially raises the lowest point of the sample fluid therein, facilitating its collection. As elsewhere described herein, many automated sampling systems include a collection tube that extends into a sample well a specified or predefined distance. However, many existing sample wells (such as the test tube 200) require increased sample volume to accommodate the predefined distance of the collection tube. The cavity 130 of the sample container 100 provides a raised cavity within the test tube 200 that can accommodate the predefined distance of the collection tube. Specifically, the sample container 100 removes the need to dilute and/or increase the sample volume of the fluid within the cavity 130.

In other implementations, the sample well supporting and retaining the sample container 100 is one of a plurality of sample wells. For example, FIG. 4 shows a multi-well plate 300 defining a plurality of sample wells 302. Each sample well 302 of the multi-well plate 300 is substantially similar to each other, such that reference numbers for any one sample well 302 are interchangeable with any other sample well 302. Similar to the test tube 200 of FIG. 3, each of the sample wells 302 in FIG. 4 include a first opening 304 defined by a top surface 306 of the multi-well plate 300. Each sample well 302 extends from the first opening 304 towards a bottom surface 308 of the sample well 302.

Each sample well 302 of the multi-well plate 300 is sized to fit a majority of the sample container 100 therein. Similar to the test tube 200, the diameter of the top end 102 of the sample container 100 is greater than or equal to a diameter of the opening 304 of each sample well 302. Thus, the sample container 100 is retained at an upper end of the sample well 302. Although FIG. 4 shows a single sample container 100 within a single sample well 302 of the multi-well plate 300, in other implementations, two or more of the sample wells 302 include a sample container 100 retained therein (e.g., each of the wells of a 96-well plate, or any other plate having a different number of wells, such as 384 wells).

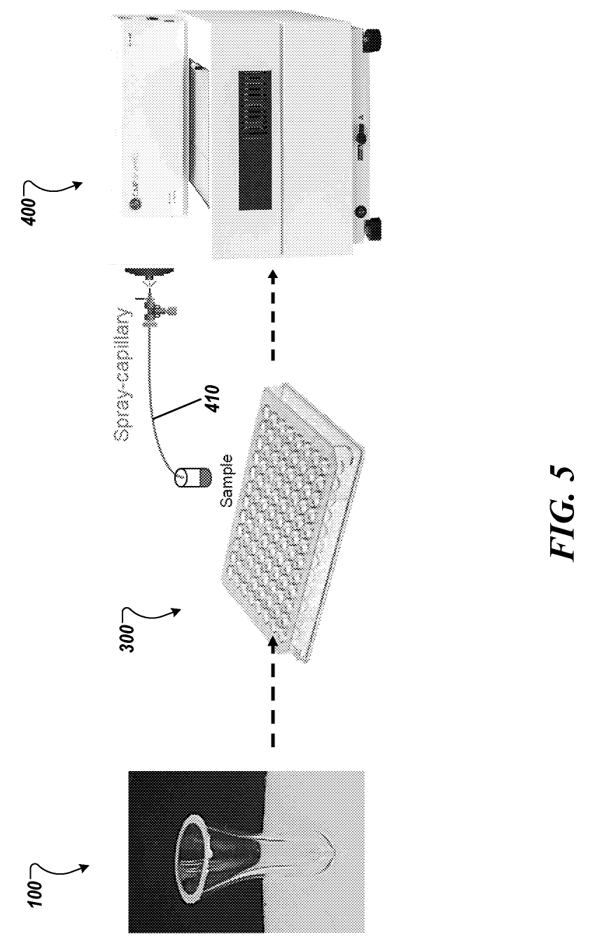

FIG. 5 shows a diagram including a sample container 100, the multi-well plate 300, and an automated sampling device 400. The automated sampling device 400 may be any one of various types of existing sampling devices or similar such devices. In some implementations, the automated sampling device includes a pipetting workstation (e.g., a 96-channel pipetting system) with motorized tips configured for sample collection. In some implementations, the automated sampling device is a high-throughput and/or benchtop pipetting device. In some implementations, the automated sampling device is a spray capillary-electrophoresis mass spectrometry, as shown in the example of FIG. 5. However, in other implementations, the automated sampling device includes various other devices and/or methods of collection and analysis.

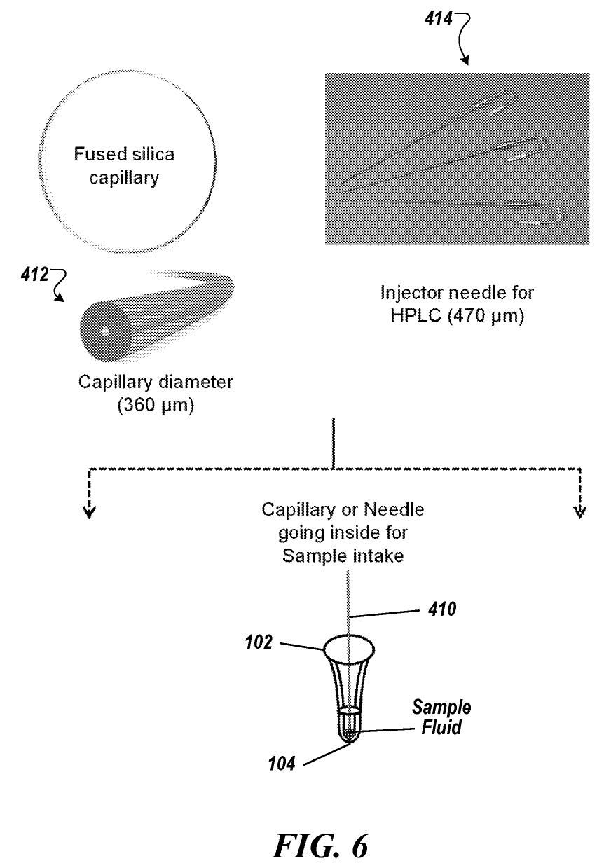

In some implementations, the automated sampling device includes a collection tube (e.g., an injector needle or a capillary) configured to insert into one or more sample wells and collect a volume of fluid from the sample well. For example, FIG. 6 shows a diagram with a sample container 100 having a collection tube 410 therein. The collection tube 410 is configured to extend into the sample container 100 (e.g., when disposed within a sample well).

In particular, the collection tube 410 of the automated sampling device 400 extends towards the bottom surface 122 of the opening 120 of the sample container 100 to contact and collect the sample fluid therein. The collection tube 410 may have an inner diameter of less than 500 micrometers.

Two examples of collection tubes are shown in FIG. 6, either of which may be used with the automated sampling device 400. However, in other implementations, another type of collection tube and/or system may be used.

FIG. 6 shows a first collection tube 412, which is a fused silica capillary having an inner diameter of 360 micrometers. The fused silica capillary making up the first collection tube 412 is a thin, flexible tube that may include high-purity silica with a polymer coating. The fused silica capillary may be used in a capillary electrophoresis collection system.

FIG. 6 further shows a second collection tube 414, which is an injector needle configured for high-performance liquid chromatography. The second collection tube 414 has an inner diameter of 470 micrometers. The injector needle is configured to draw up liquid from the cavity 130 of the sample container 100.

As elsewhere described herein, the first collection tube 412, the second collection tube 414, or any other collection tube of an automated sampling device 400 is configured to collect a low volume sample from a sample container 100. The sample container 100 provides an insert device compatible with common sample wells. The sample container 100 reduces or eliminates the need for sample dilution by, for example, raising the bottom surface of the container well relative to the predetermined location of the collection tube 410. Therefore, a low-volume, high-concentration, mass-limited sample can be collected automatically by automated sampling devices. The sample container 100 provides for direct sampling with nanoliter-level volumes, which improves sensitivity and quantitative accuracy.

Overall, the sample container or sample well insert device disclosed herein provides a highly reproduceable and consistent device for automated sampling. The dimensions and geometry of the well insert device is configurable to a wide variety of sample wells, including different existing instruments. Rather than re-configured existing sampling devices, which can be expensive and time consuming, the disclosed sample container provides a quick and seamless solution for mass limited sampling in existing sampling devices.

For purposes of this description, certain advantages and novel features of the aspects and configurations of this disclosure are described herein. The described methods, systems, and apparatus should not be construed as limiting in any way. Instead, the present disclosure is directed toward all novel and nonobvious features and aspects of the various disclosed aspects, alone and in various combinations and sub-combinations with one another. The disclosed methods, systems, and apparatus are not limited to any specific aspect, feature, or combination thereof, nor do the disclosed methods, systems, and apparatus require that any one or more specific advantages be present or problems be solved.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

Features disclosed in this specification (including any accompanying claims, abstract, and drawings), and/or all of the steps of any method or process so disclosed, may be combined in any combination, except combinations where at least some of such features and/or steps are mutually exclusive. The claimed features extend to any novel one, or any novel combination, of the features disclosed in this specification (including any accompanying claims, abstract, and drawings), or to any novel one, or any novel combination, of the steps of any method or process so disclosed.

As used in the specification and the appended claims, the singular forms “a”, “an”, and “the” include plural referents unless the context clearly dictates otherwise. Ranges may be expressed herein as from “about” one particular value, and/or to “about” another particular value. When such a range is expressed, another aspect includes from the one particular value and/or to the other particular value. Similarly, when values are expressed as approximations, by use of the antecedent “about”, it will be understood that the particular value forms another aspect. It will be further understood that the endpoints of each of the ranges are significant both in relation to the other endpoint, and independently of the other endpoint. The terms “about” and “approximately” are defined as being “close to” as understood by one of ordinary skill in the art. In one non-limiting aspect the terms are defined to be within 10%. In another non-limiting aspect, the terms are defined to be within 5%. In still another non-limiting aspect, the terms are defined to be within 1%.

The terms “coupled”, “connected”, and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

Certain terminology is used in the following description for convenience only and is not limiting. The words “right”, “left”, “lower”, and “upper” designate direction in the drawings to which reference is made. The words “inner” and “outer” refer to directions toward and away from, respectively, the geometric center of the described feature or device. The words “distal” and “proximal” refer to directions taken in context of the item described and, with regard to the instruments herein described, are typically based on the perspective of the practitioner using such instrument, with “proximal” indicating a position closer to the practitioner and “distal” indicating a position further from the practitioner. The terminology includes the above-listed words, derivatives thereof, and words of similar import.

Throughout the description and claims of this specification, the word “comprise” and variations of the word, such as “comprising” and “comprises”, means “including but not limited to”, and is not intended to exclude, for example, other additives, components, integers or steps. “Exemplary” means “an example of” and is not intended to convey an indication of a preferred or ideal aspect. “Such as” is not used in a restrictive sense, but for explanatory purposes.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the form disclosed. Many modifications and variations will be apparent to those of ordinary skill in the art without departing from the scope and spirit of the present disclosure.

What is claimed is:

1. A sample container comprising:
a tapering body extending from a top end to a tip end of the sample container along a central longitudinal axis, the tip end having a first diameter smaller than a second diameter of the top end of the tapering body, the tapering body having an outer surface and an inner surface with a thickness defined between the outer surface and the inner surface,
an opening defined on the top end of the tapering body; and
a cavity defined by the inner surface of the tapering body to be in fluid communication with the opening,
wherein the tip end of the sample container is configured to fit within a sample well to facilitate automated collection of a sample fluid disposed within the cavity by an external collection device.

2. The sample container of claim 1, wherein a volume of the sample fluid disposed in the cavity is less than 1000 nanoliters.

3. The sample container of claim 1, wherein the sample well is a test tube defining a test tube opening in fluid communication with the sample well, wherein the sample well is sized to fit a majority of the sample container therein, wherein the second diameter of the top end of the tapering body is greater than or equal to a diameter of the test tube opening such that the sample container is retained on an upper end of the test tube.

4. The sample container of claim 1, wherein the sample well is one of a plurality of sample wells defined in a multi-well plate, the sample well extending from a first opening defined by a top surface of the multi-well plate towards a bottom surface of the sample well, wherein the sample well is sized to fit a majority of the sample container therein, wherein the second diameter of the top end of the tapering body is greater than or equal to a diameter of a first opening such that the sample container is retained on an upper end of the sample well.

5. The sample container of claim 4, wherein the tip end of the sample container is spaced apart from the bottom surface of the sample well.

6. The sample container of claim 1, wherein the tapering body comprises glass.

7. The sample container of claim 1, wherein the first diameter is less than or equal to 4 millimeters and the second diameter is at least 5 millimeters.

8. The sample container of claim 1, wherein a height of the sample container from the tip end to the top end is at least 8 millimeters.

9. The sample container of claim 1, wherein the tapering body is substantially cone-shaped, and the corresponding cavity defined by the inner surface is substantially cone-shaped.

10. The sample container of claim 1, wherein the opening on the top end of the tapering body has an oblong shape in a direction perpendicular to the central longitudinal axis.

11. A sampling system to facilitate automated sample collection, the sampling system comprising:
a plate comprising:
an upper surface defining a plurality of openings, including a first opening; and
a plurality of sample wells defined in the plate, wherein the plurality of sample wells extends from and is in fluid communication with the plurality of openings, including a first sample well extending from the first opening, wherein each of the plurality of sample wells includes a bottom,
wherein the plate is configured to be mounted within an automated sampling device; and
at least one sample container, including a first sample container configured to be placed within the first sample well, the at least one sample container comprising:
a tapering body extending from a top end to a tip end of the at least one sample container along a central longitudinal axis, the tip end having a first diameter smaller than a second diameter of the top end of the tapering body, the tapering body having an outer surface and an inner surface with a thickness defined between the outer surface and the inner surface,
an opening defined on the top end of the tapering body; and
a cavity defined by the inner surface of the tapering body to be in fluid communication with the opening,
wherein, when the first sample container is disposed within the first sample well, the tip end of the first sample container is spaced apart from the bottom of the first sample well such that the first sample container is disposed on an upper portion of the first sample well to facilitate automated collection of a sample fluid disposed within the cavity of the first sample container by the automated sampling device.

12. The sampling system of claim 11, wherein the at least one sample container further comprises a second sample container configured to be disposed within a second sample well of the plurality of sample wells of the plate, wherein the second sample well is spaced apart from the first sample well in a lateral direction that is perpendicular to a longitudinal axis of the first sample well.

13. The sampling system of claim 11, wherein the automated sampling device comprises a sample collection tube configured to extend into the first sample container disposed within the first sample well.

14. The sampling system of claim 13, wherein the sample collection tube extends towards a bottom of the cavity of the first sample container to contact and collect the sample fluid therein.

15. The sampling system of claim 13, wherein the sample collection tube of the automated sampling device has a diameter of less than 500 micrometers.

16. The sampling system of claim 11, wherein the plate is a 96-well plate and the plurality of sample wells comprises 96 sample wells.

17. The sampling system of claim 11, wherein a volume of the sample fluid disposed in the cavity of the first sample container is less than 1000 nanoliters.

18. The sampling system of claim 11, wherein the tapering body of the first sample container comprises glass.

19. The sampling system of claim 11, wherein the tapering body of the first sample container is substantially cone-shaped, and the corresponding cavity defined by the inner surface is substantially cone-shaped.

20. The sampling system of claim 11, wherein the opening on the top end of the tapering body of the first sample container has an oblong shape in a direction perpendicular to the central longitudinal axis.
